(19) United States
(12) Patent Application Publication
(10) Pub. No.: US 2010/0009671 A1
(43) Pub. Date: Jan. 14, 2010

(54) AUTOMATIC DATA CAPTURE WHEN WIRELESS SERVICE DISRUPTION IS DETECTED

(75) Inventors: Stuart O. Goldman, Scottsdale, AZ (US); Kevin Hannan, Lisle, IL (US); Paul D. Wolfson, Evanston, IL (US); Richard E. Krock, Naperville, IL (US); Karl F. Rauscher, Emmaus, PA (US); James P. Runyon, Wheaton, IL (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES, INC., Murray Hill, NJ (US)

(21) Appl. No.: 12/169,147

(22) Filed: Jul. 8, 2008

(51) Int. Cl. H04Q 7/20

(52) U.S. Cl. 455/423; 370/241

(57) ABSTRACT

A method is provided in a wireless telecommunications network (10) for capturing data regarding mobile stations (40) served by the network (10). The method includes: monitoring a designated geographic area provided wireless service by the telecommunications network (10) to detect call failures occurring in the monitored area; counting a number of failures detected via the monitoring that occur within a designated timeframe; comparing the counted number of failures to a threshold value; and, in response to the counted number of failures exceeding the threshold value, recording data regarding mobile stations (40) served by the network (10) that are recognized by the network (10) as at least one of in or near the monitored area.

### FIELD

The present inventive subject matter relates to the telecommunication arts. Particular application is found in conjunction with wireless and/or cellular telecommunication networks, and the specification makes particular reference thereto. However, it is to be appreciated that aspects of the present inventive subject matter are also amenable to other like applications and/or systems.

### BACKGROUND

Government and/or other agencies are generally interested in developing and/or making available systems and/or mechanisms to support situational analysis and/or recovery efforts in times of public emergency that concern, e.g., localized or particular geographic areas. For example, when a natural disaster strikes or other like accident or calamity occurs in a particular geographic area, there may generally be an interest in obtaining information about individuals potentially affected by and/or involved in the incident, e.g., the total number of individuals affect and/or involved, the identity and/or location of specific individuals affected and/or involved, the relative safety of individuals in the affect area, etc.

For example, typical emergencies where the aforementioned information may be useful can include natural disasters such as floods, earth quakes, tornadoes, hurricanes, blizzards or avalanches, forest fires, etc. Other emergencies may include accidents, e.g., freeway pile-ups or automobile accidents, structures such as bridges or buildings collapsing or failing, airplane crashes, dam or levee breaks, etc. Still other incidents may be the intentional work of one or more nefarious perpetrators, e.g., bombings, terrorist attacks, arson, mass shooting sprees, etc. In any event, to assist in the situational analysis and/or any subsequent recovery effort, it would be generally beneficial to be able to obtain selected information about any individuals that may potentially be affected by and/or involved in the incident, e.g., either as victims or perpetrators or both. For example, a list of potential victims in the vicinity of the disaster when it occurred could greatly enhance a recovery effort by informing the rescuers of the number, identity and/or location of those individual thought to be at risk or affected. Accordingly, rescue workers and/or resources could be properly apportioned and/or directed in view of the foregoing information. Additionally, in the case of criminal or other nefarious activities, a list of nearby individuals at the time of the disaster may provide law enforcement or other interested agencies leads regarding potential perpetrators. However, heretofore, a reliable, practical and/or otherwise suitable mechanism and/or system to obtain such information in the wake of a localized disaster or emergency has not been developed.

Accordingly, a new and improved system and/or method for obtaining information about individuals potentially affected by and/or involved in a disaster or emergency situation in a particular geographic area is disclosed that addresses the above-referenced problems and others.

### SUMMARY

In accordance with one embodiment, a method is provided in a wireless telecommunications network for capturing data regarding mobile stations served by the network. The method includes: monitoring a designated geographic area provided wireless service by the telecommunications network to detect call failures occurring in the monitored area; counting a number of failures detected via the monitoring that occur within a designated timeframe; comparing the counted number of failures to a threshold value; and, in response to the counted number of failures exceeding the threshold value, recording data regarding mobile stations served by the network that are recognized by the network as at least one of in or near the monitored area.

In accordance with another embodiment, a system is provided in a wireless telecommunications network for capturing data regarding mobile stations served by the network. The system includes: monitoring means for monitoring a designated geographic area provided wireless service by the telecommunications network to detect call failures occurring in the monitored area; counting means for counting a number of failures detected via said monitoring means that occur within a designated timeframe; comparing means for comparing the counted number of failures to a threshold value; and, recording means that, in response to the counted number of failures exceeding the threshold value, record data regarding mobile stations served by the network that are recognized by the network as at least one of in or near the monitored area.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is box diagram showing an exemplary cellular or wireless telecommunications network suitable for practicing aspects of the present inventive subject matter.

FIG. 2 is a flow chart showing an exemplary process or method in accordance with aspects of the present inventive subject matter for obtaining information about individuals potentially affected by and/or involved in a disaster or emergency situation in a particular geographic area.

### DETAILED DESCRIPTION OF PREFERRED EMBODIMENTS

For clarity and simplicity, the present specification shall refer to structural and/or functional elements, entities and/or facilities, relevant standards, protocols and/or services, and other components that are commonly known in the telecommunication arts without further detailed explanation as to their configuration or operation except to the extent they have been modified or altered in accordance with and/or to accommodate the preferred embodiment(s) presented herein.

Wireless, cellular or mobile telecommunications networks are generally known in the art. Commonly, a mobile station (MS) (e.g., a mobile telephone or other mobile or cellular or wireless end user device) obtains service and/or access to the wireless network via an over-the-air radio frequency (RF) interface with a base station (BS). Each BS provides the over-the-air interface for and/or serves a particular geographic coverage area known as a cell, which may be further subdivided into cell sectors as is known in the art. Typically, a plurality of base stations are operatively connected to and/or served by a mobile switching center (MSC) that is responsible for routing traffic for a particular MS to the appropriate BS currently serving that MS (i.e., to the cell in which the MS is currently located).

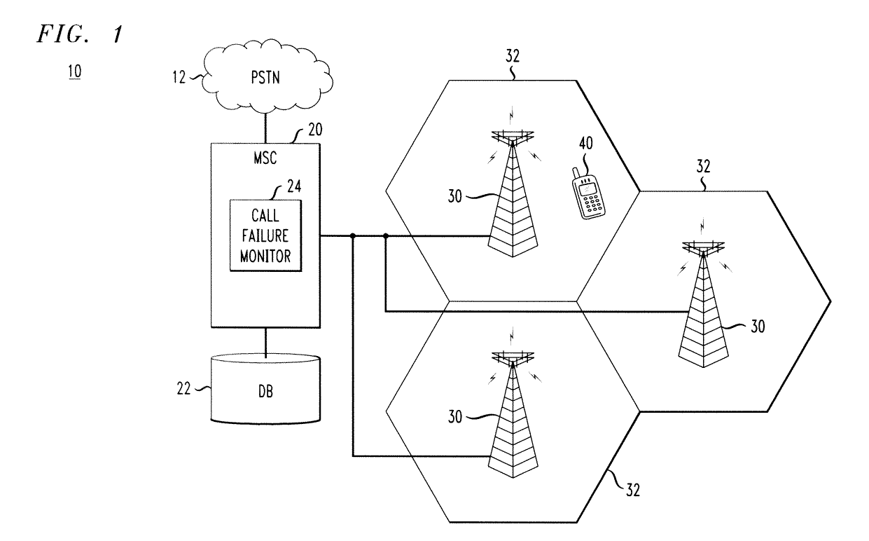

With specific reference now to FIG. 1, a cellular or wireless telecommunications network 10 includes a MSC 20 that suitably may be operatively connected to and/or in communication with a public switched telephone network (PSTN) 12 in the usual manner. As shown, the MSC 20 is also operatively connected to and/or in communication with a plurality of base stations 30 in the usual manner. As is understood in the art, each BS 30 provides an over-the-air RF or other like interface for its respective geographic area or cell 32. Selectively, a MS (such as the exemplary MS 40 illustrated in FIG. 1) is provided telecommunication services and/or otherwise accesses the network 10 via the over-the-air interface and/or BS 30 serving the cell 32 in which the MS 40 is located.

While only one MSC is illustrated in FIG. 1 for purposes of simplification and clarity, it is to be appreciated that the network 10 may in fact include any number of one or more MSCs that are similarly situated and/or arranged. Additionally, while three BS 30 and three corresponding cells 32 are illustrated in FIG. 1, it is to be appreciated that more or less than three base stations and/or cells may be similarly situated with respect to any of the one or more MSCs in the network 10. That is to say, each MSC in the network 10 may optionally serve any number of one or more base stations and/or corresponding cells. Additionally, while only one exemplary MS is illustrated in FIG. 1, the network 10 optionally serves any number of one or more mobile stations similarly situated and/or arranged in any of the one or more cells 32.

As previously indicated herein, the present specification is generally directed to a system and/or method for obtaining information about individuals potentially affected by and/or involved in a disaster or emergency situation in a particular geographic area. Suitably, this is achieved using a cellular or wireless telecommunications network, e.g., such as the network 10 illustrated in FIG. 1. In particular, the use of mobile telephones and/or other mobile stations by individuals has become somewhat ubiquitous. Moreover, the operational state and/or location of an individual's MS is often strongly associated with the state and/or location of that individual. Accordingly, by monitoring and/or recording the operational state and/or location of mobile stations served by the network 10 at the time of and/or in the vicinity of a disaster, the network 10 is able to obtain valuable information about individuals potentially affected by and/or involved in the disaster or emergency situation.

In accordance with one suitable embodiment, the network 10 uses an unexpected bulk failure or other like disconnect of multiple wireless or cellular calls in a limited geographic region (e.g., in one particular cell or a limited number of neighboring or nearby cells or one or more specific cell sectors neighboring or nearby one another in one or more cells) within a set or otherwise determined time window as a trigger which indicates a potential disaster or emergency situation. As is understood in the art, wireless or cellular calls (e.g., connected over the network 10) may unexpectedly fail or become disconnected from time-to-time. For example, dropped calls (as they are commonly known in the art) may typically result from a loss of signal strength on the over-the-air interface between the MS 40 and BS 30, or due to the MS unexpectedly powering-off or down during a call, or due to other reasons which unexpectedly or otherwise interrupt the over-the-air connection between the MS 40 and the BS 30. Generally, when occurring in isolated or relatively rare instances in disparate cells or locations, a few dropped calls or call disconnects is likely not to be indicative of any significant disaster or emergency. On the other hand, a relatively large number of dropped calls or unexpected call failures or other call disconnects occurring together in a relatively short time period (e.g., simultaneously or nearly simultaneously) and concentrated in one cell or a collection of neighboring cells or other common location or in relatively close proximity to one another is potentially a sign of a disaster or emergency affecting that geographic area. Accordingly, when the network 10 detects the foregoing, one or more lists or the like are generated and/or recorded within the network 10 to capture known information about the mobile stations in or near the affected region. For example, this information may optionally include: the directory number (DN), telephone number or other like identifier or ID assigned to the MS, subscriber information (e.g., name, address, etc.) for the owner or user of the MS, the operational state of the MS, the location of the MS (e.g., the last known cell or cell sector or the like used by the MS to access the network 10), etc. Suitably, this data is then optionally time and/or date stamped and stored (e.g., in a database (DB) such as the exemplary DB 22 illustrated in FIG. 1) for a set or otherwise determined period (e.g., 24 hours) so as to be accessible during the storage period by interested governmental agencies or other authorities in the event of an actual disaster or emergency or in the event that the information is otherwise desired. For example, this information may be of value to assist in situational analysis of any disaster or emergency that occurred and/or to assist in the mounting of recovery efforts. Alternately, in the case of false triggers (i.e., the disconnects or dropped calls were not the result of a disaster or emergency situation), then no significant harm or damage has been done insomuch as optionally the lists or otherwise recorded data are automatically erased, deleted, removed, purged or otherwise eliminated from the network 10 and/or the DB 22 once the storage period has ended or timed-out, e.g., without having to be accessed by the authorities.

Generally, in practice, call failures and/or disconnects are monitored within the network 10. In effect, the number “N” of failures and/or disconnects detected within a designated and/or optionally configurable proximity to one another and occurring within a designated and/or optionally configurable time period are counted. If the number N exceeds a designated and/or optionally configurable threshold “TH,” then the event trigger is activated, i.e., a disaster or emergency situation is deemed to have been detected. Suitably, activation of the event trigger causes the network 10 to record and/or store selected information about the mobile stations known to be in and/or near the area or region (i.e., in the one or more cells, cell sectors, etc.) which prompted the activation of the event trigger.

More specifically, with reference to FIG. 1, suitably the MSC 20 is equipped or otherwise provisioned with a call failure or disconnect monitor 24 that monitors each cell 32 or cell sector served by the MSC 20 for unexpected call failures or other like disconnects occurring therein within a given timeframe or period (optionally a configurable or adjustable timeframe or period). For each detected call failure or disconnect in the monitored geographic area (i.e., cell 32 or cell sector or other such region), a counter or the like is optionally incremented to keep a running total thereof within the given timeframe, or alternately, a count of the detected failures/disconnects is otherwise maintained. For example, the timeframe can be implemented and/or envisioned as a moving window with the leading edge thereof advancing with the current time. Accordingly, newly detected failures/disconnects (i.e., those entering from the leading edge of the moving window) tend to increase the running total, while older detected failures/disconnects (i.e., those exiting from the trailing edge of the moving window) tend to decrease the running total. In any event, for notation purposes herein, “N” shall be used to indicate this count or the number of call failures/disconnects detected in the monitored geographic area occurring within the given timeframe or window. If N exceeds a designated and/or optionally configurable threshold “TH,” then the event trigger is activated, i.e., a disaster or emergency situation is deemed to have been detected. Suitably, activation of the event trigger causes selected information about the mobile stations known to be in and/or near the monitored area or region to be recorded and/or stored, e.g., in the DB 22.

Suitably, selected data or information is recorded and/or stored in the DB 22 for each MS known to be at the time in the monitored geographic area (i.e., in the cell 32 or cell sector or the like) which prompted the activation of the event trigger. Optionally, in addition to and/or along with the selected data or information for each MS known to be at the time in the monitored geographic region which prompted activation of the event trigger, selected data and/or information for each MS known to be at the time in the cells or cell sectors surrounding or in relatively close proximity to the monitored geographic region is also recorded and/or stored in the DB 22, e.g., optionally in a separate list. Suitably, the recorded or otherwise captured data is optionally time and/or date stamped and stored (e.g., in DB 22) for a designated and/or optionally configurable storage period so as to be accessible during the storage period by interested governmental agencies or other authorities as desired. Optionally, once the storage period has ended or timed-out, the captured data is automatically erased, deleted, removed, purged or otherwise eliminated from the network 10 and/or the DB 22.

In suitable embodiments, the captured data regarding the mobile stations in or near the monitored region can include any of a variety of known information relating to the mobile stations, including for example, the DN, telephone number or other ID assigned to the MS, subscriber information (e.g., name, address, etc.) for the owner or user of the MS, the operational state of the MS, the location of the MS (e.g., the last known cell or cell sector or the like used by the MS to access the network 10), etc. Optionally, the captured data is organized or sorted into one or more separate lists. For example, one list can contain data or information for those mobile stations that were engaged in calls at the time of the event trigger; another list can include data or information for those mobile stations that had calls fail or disconnect thereby resulting in the event trigger being activated; yet another list can include data and/or information for those mobile stations that were not engaged in calls at the time but were otherwise registered in a cell in or near the monitored region at the time of the event trigger activation; and so on for various different scenarios and/or different operational states of respective mobile stations.

As can be appreciated, the foregoing information can be of significant value, e.g., in mounting rescue and/or recovery efforts and/or to assist in the situational analysis of a disaster or emergency. For example, an interested individual or agency could look at the information in the DB 22 along with current MS registry information (e.g., in a Home Location Register (HLR) or Visitor Location Register (VLR) or other like register or DB of the network 10) to determine the status of the respective mobile stations and by association their users or owners.

For example, one simple rescue effort may be to call the mobile stations listed in the DB 22 to see if the individual users answer the call, and if the call is answer, the rescuer(s) could check on their whereabouts and/or safety. Alternately, if there is no answer, the network 10 could be used to check if the MS is powered-up and/or to determine the current registered location of the MS. That is to say, the MS may have remained or otherwise stayed in or near the disaster area and is currently registered in a cell that resides in or near the disaster area, or alternately the MS may have moved away to another cell (e.g., a safe distance from the disaster area) and registered therein. In the latter case then, rescuers can assume that the MS user or owner has likely made their way out of danger without significant harm and/or is no longer in need of immediate rescue efforts.

As for those MS remaining in or near the disaster area (e.g., according to registration information available from the network 10) and that are powered-up but which have not answered the aforementioned call optionally placed thereto by rescuers, one or more various technologies may be used to determine the whereabouts of the MS, e.g., so that rescue efforts can be focused on their location. For example, the MS 40 is optionally equipped with a global positioning system (GPS) receiver or other like device from which the location of the MS 40 can be obtained. Alternately, a network or MS-based technique is employed to determine or measure the location of the MS 40, e.g., using the over-the-air interfaces and/or signals exchanged between the MS 40 and one or more of the BS 30. For example, suitable known network and/or MS-based solutions for determining the location of the MS 40 include, without limitation: observed time difference (OTD); time of arrival (TOA); time difference of arrival (TDOA); angle of arrival (AOA); multipath fingerprinting; timing advance (TA); enhanced forward link triangulation (E-FLT); received signal strength (RSS); etc. Optionally, a hybrid location determination solution combining one or more of the aforementioned techniques is employed or so-called assisted-GPS may also be employed.

In yet another example, optionally in cases where a MS is listed in the DB 22 but is no longer powered-up and/or cannot be located by the network 10, using reverse directory look-ups and/or other like mechanisms along with subscriber information such as the subscriber's address, rescuers may attempt to contact the individual or a friend or relative, e.g., at the telephone number (e.g., home or other like telephone number) associated in the reverse directory look-up with the subscriber's address. Finally, any MS identified in the DB 22 for which the status or condition remains undetermined or otherwise unresolved after one or more of the foregoing efforts have been exhausted may optionally be considered to represent a still “missing” and/or potential victim on which rescue efforts can be focused or concentrated as desired.

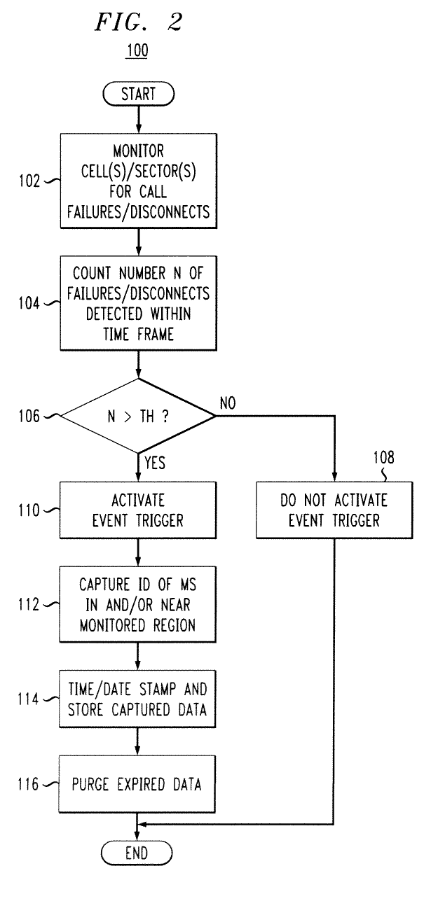

With added reference now to FIG. 2, there is shown an exemplary process and/or method 100 carried out by and/or within the network 10 to achieve one or more of the desired results described herein. As shown, at step 102, the MSC 20 and/or monitor 24 monitors a designated and/or optionally configurable geographic region (e.g., one or more cells 32 or one or more cell sectors or some combination thereof) for unexpected call failures or other like disconnects occurring therein. At step 104, a running total of the number N of the call failures/disconnects detected in step 102 within a designated and/or optionally configurable timeframe, period or window is calculated and/or otherwise maintained or determined.

At decision step 106, N is compared to a designated and/or optionally configurable threshold TH. Suitably, if N does not exceed TH, then no significant disaster or emergency is deemed to be detected in the monitored region and accordingly the event trigger is not activated, e.g., as indicated in box or step 108. Alternately, if N does exceed TH, then a significant disaster or emergency is deemed to be detected in the monitored region and accordingly the event trigger is activated, e.g., as indicated in box or step 110.

In response to activation of the event trigger, at step 112, suitably the network 10 or MSC 20 captures the ID (e.g., DN or telephone number or other ID) of mobile stations (e.g., such as the MS 40) known to be in or around the monitored region (e.g., in the monitored cell(s) 32 or cell sector(s) or in neighboring or otherwise nearby cells or cell sectors), optionally, along with other relevant data regarding the mobile stations. Suitably, the network 10 and/or MSC 20 recognizes which MS are in or around the monitored region based upon available registration information (e.g., obtained from a HLR or VLR or other like registry or DB) indicative of the cell or cell sector in which the MS resides or the cell or cell sector last used by the MS to access the network 10.

At step 114, the captured data from step 112 is optionally time and/or date stamped and recorded or stored, e.g., in the DB 22, optionally for a designated and/or optionally configurable time period. Suitably, as shown in FIG. 2, at the expiration of the storage period (e.g., as determined from the time/date stamp) the stored data is automatically deleted, removed, eliminated or otherwise purged, e.g., from the DB 22.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. In a wireless telecommunications network, a method for capturing data regarding mobile stations served by the network, said method comprising:
(a) monitoring a designated geographic area provided wireless service by the telecommunications network to detect call failures occurring in the monitored area;
(b) counting a number of failures detected via said monitoring that occur within a designated timeframe;
(c) comparing the counted number of failures to a threshold value; and,
(d) in response to the counted number of failures exceeding the threshold value, recording data regarding mobile stations served by the network that are recognized by the network as at least one of in or near the monitored area.

2. The method of claim 1, wherein the method further includes:
(e) storing the recorded data in a designated location.

3. The method of claim 2, wherein the method further includes:
(f) automatically purging the stored data from the designated location upon expiration of a designated time period.

4. The method of claim 1, wherein the recorded data includes an identifier for each mobile station having data recorded therefor.

5. The method of claim 1, wherein the monitored area includes at least one of a cell included in the network or a sector within a cell included in the network.

6. The method of claim 1, wherein the recording step is not performed if the counted number of failures does not exceed the threshold value.

7. In a wireless telecommunications network, a system for capturing data regarding mobile stations served by the network, said system comprising:
monitoring means for monitoring a designated geographic area provided wireless service by the telecommunications network to detect call failures occurring in the monitored area;
counting means for counting a number of failures detected via said monitoring means that occur within a designated timeframe;
comparing means for comparing the counted number of failures to a threshold value; and,
recording means that, in response to the counted number of failures exceeding the threshold value, record data regarding mobile stations served by the network that are recognized by the network as at least one of in or near the monitored area.

8. The system of claim 7, said system further comprising:
storage means for storing the recorded data in a designated location.

9. The system of claim 8, said system further comprising:
means for automatically purging the stored data from the storage means upon expiration of a designated time period.

10. The system of claim 7, wherein the recorded data includes an identifier for each mobile station having data recorded therefor.

11. The system of claim 7, wherein the monitored area includes at least one of a cell included in the network or a sector within a cell included in the network.

12. The system of claim 7, wherein the recording means does not record the data if the counted number of failures does not exceed the threshold value.
